(19) United States
(12) Patent Application Publication
(10) Pub. No.: US 2018/0299572 A1
(43) Pub. Date: Oct. 18, 2018

(54) FORMATION PROPERTY DETERMINATION WITH MULTIFREQUENCY MULTICOMPONENT INDUCTION LOGGING

(71) Applicant: Halliburton Energy Services, Inc., Houston, TX (US)

(72) Inventors: Junsheng Hou, Kingwood, TX (US); Luis Emilio San Martin, Houston, TX (US); Glenn A. Wilson, Houston, TX (US)

(21) Appl. No.: 15/767,915

(22) PCT Filed: Nov. 19, 2015
(86) PCT No.: PCT/US2015/061542

§ 371 Date: Apr. 12, 2018

(51) Int. Cl. G01V 1/30; G01V 3/28

(52) U.S. Cl. CPC G01V 1/307; G01V 2210/626; G01V 3/28; G01V 1/306

(57) ABSTRACT

In some embodiments, an apparatus and a system, as well as methods, include operating to estimate a range of true resistivity in a geological formation, based on measurements made over multiple frequencies. Further activity may comprise selecting a subset of the measurements associated with at least one measurement frequency included in the multiple frequencies, based on the range of the true resistivity, to determine a value of a property of the geological formation. Additional methods, apparatus, and systems are disclosed.

### BACKGROUND

Understanding the structure and properties of geological formations may reduce the cost of drilling wells for oil and gas exploration. Measurements are typically performed in a borehole (i.e., down hole measurements) in order to attain this understanding. For example, the measurements may identify the composition and distribution of material that surrounds the measurement device down hole. To obtain such measurements, a variety of sensors and mounting configurations may be used.

Measurement apparatus that make use of these sensors and mounting configurations include tools that are used to determine formation resistivity. These tools can sometimes be operated over a range of frequencies.

### BRIEF DESCRIPTION OF THE DRAWINGS

FIG. 1 is a physical and conceptual representation of a multi-frequency, multi-component induction (MCI) tool, according to various embodiments.

FIG. 2 is a graph of skin depth versus formation true resistivity (Rt=0.2-5 ohm-m) over a range of operational frequencies for the MCI tool of FIG. 1.

FIG. 3 is a graph of skin depth versus formation true resistivity (Rt=5-200 ohm-m) over a range of operational frequencies for the MCI tool of FIG. 1.

FIG. 4 illustrates simulated MCI responses (XX, XZ, YY, and ZZ) for array A1 of the MCI tool of FIG. 1, with dip=0 degrees, according to various embodiments.

FIG. 5 illustrates simulated MCI responses (XX, XZ, YY, and ZZ) for array A4 of the MCI tool of FIG. 1, with dip=0 degrees, according to various embodiments.

FIG. 6 illustrates simulated MCI responses (XX, XZ, YY, and ZZ) for array A1 of the MCI tool of FIG. 1, with dip=65 degrees, according to various embodiments.

FIG. 7 illustrates simulated MCI responses (XX, XZ, YY, and ZZ) for array A4 of the MCI tool of FIG. 1, with dip=65 degrees, according to various embodiments.

FIG. 8 is a workflow diagram for a method of frequency selection and processing MCI tool measurements, according to various embodiments.

FIG. 9 is a block diagram of a logging system according to various embodiments.

FIG. 10 is a flow diagram for a method of MCI tool frequency selection, according to various embodiments.

FIG. 11 depicts an example wireline system, according to various embodiments.

FIG. 12 depicts an example drilling rig system, according to various embodiments.

### DETAILED DESCRIPTION

In order to improve the quality of data obtained as a result of MCI tool operation, skin-depth, linear/nonlinear response patterns, and bi-frequency MCI relationships are used to select one or more frequencies from among several that may be available for the measurement of formation properties. The apparatus, systems, and methods disclosed herein can be used in real time, as part of a new and practical workflow to enhance measurement, data processing, and interpretation. The details of how these embodiments can be implemented will be explained in the following paragraphs.

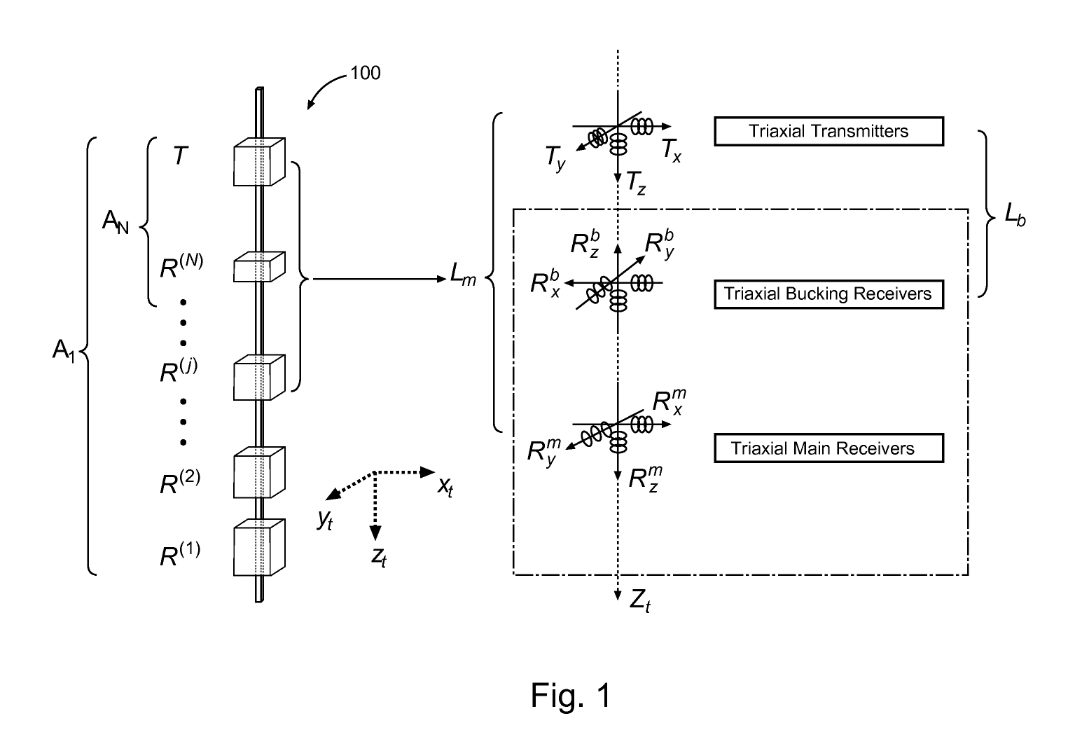

FIG. 1 is a physical and conceptual representation of a multi-frequency, multi-component induction (MCI) tool 100, according to various embodiments. This tool 100 comprises N tri-axial subarrays (i.e., A₁, . . . A_{N}), with each subarray including three mutually orthogonal collocated transmitters, and three mutually orthogonal main and bucking collocated receivers, respectively.

Some MCI tools have been commercialized and deployed to evaluate formations. Most of these tools, such as the Halliburton Xaminer™-MCI tool, available from Halliburton Energy Services of Houston, Tex., operate at multiple frequencies. In general, the wider the band of available frequencies, the more easily the tool can be used in a variety of formation evaluation tasks. MCI measurements at multiple frequencies have a degree of redundancy that is useful for cross-validating measurements, to derive better and more accurate tool applications. In order to enhance the MCI measurement processing and interpretation, the available range of frequencies can be narrowed via selection algorithms to produce improved results.

To accomplish the selection, it can be assumed that the tool 100 shown in FIG. 1 is used. Here each tri-axial subarray A₁, . . . A_{N} comprises a transmitter triad (Tₓ, T_{y}, and Tₓ), and separate main and bucking receiver triads, (Rₓ^{m}, R_{y}^{m} and R_{z}^{m}) and (Rₓ^{b}, R_{y}^{b}, and R_{z}^{b}), respectively. Each triad, in turn, comprises three mutually orthogonal collocated multi-turn coil antennas. Lₘ and L_{b} denote the transmitter-receiver spacing of the main and bucking receivers, respectively. Accordingly, each triaxial subarray may produce a nine-coupling voltage/magnetic-field measurement at every logging depth in the tool coordinate system denoted by (xₜ, yₜ, zₜ).

The voltages (resulting from magnetic fields) measured for all transmitter and receiver combinations are converted into apparent conductivities. In general, the apparent conductivities are symbolically expressed as a 3×3 tensor or matrix for the multi-array tri-axial tool operated at multiple frequencies. Two equivalent representations are shown using Equations (1) and (2) as follows:

$$\begin{matrix}\overline{\overline{{σ}_{a}^{( i , j )}}} = ( \begin{matrix}{σ}_{xx}^{( i , j )} & {σ}_{xy}^{( i , j )} & {σ}_{xz}^{( i , j )} \\ {σ}_{yx}^{( i , j )} & {σ}_{yy}^{( i , j )} & {σ}_{yz}^{( i , j )} \\ {σ}_{zx}^{( i , j )} & {σ}_{zy}^{( i , j )} & {σ}_{zz}^{( i , j )}\end{matrix} ) = {( {σ}_{IJ}^{( i , j )} )}_{( 3 \times 3 )} , & ( 1 ) \\ or & \\ \overline{\overline{{σ}_{a}^{( i , j )}}} = ( \begin{matrix}{XX}^{( i , j )} & {XY}^{( i , j )} & {XZ}^{( i , j )} \\ {YX}^{( i , j )} & {YY}^{( i , j )} & {YZ}^{( i , j )} \\ {ZX}^{( i , j )} & {ZY}^{( i , j )} & {ZZ}^{( i , j )}\end{matrix} ) = {( {IJ}^{( i , j )} )}_{( 3 \times 3 )} , & ( 2 )\end{matrix}$$

where I,J=x/X,y/Y,z/Z; i=1, 2, . . . , N;

j=1, 2, . . . , M; σ̅ₐ̅^̅{̅(̅i̅,̅j̅)̅}̅ is referred to as the MCI apparent conductivity tensor (real (R) or imaginary (X) signal) in the tool coordinate system; and σ_{IJ}^{(i,j)}/IJ^{(i,j)} are the measured-conductivity couplings of σ̅ₐ̅^̅{̅(̅i̅,̅j̅)̅}̅, where the first subscript I indicates the transmitter direction, and the second subscript J indicates the receiver direction.

For example, when I, J=x/X, σ_{IJ}^{(i,j)} is σₓₓ^{(i,j)} (or XX^{(i,j)}); when I, J=y or Y, σ_{IJ}^{(i,j)} is σ_{yy}^{(i,j)} (or YY^{(i,j)}); and when I, J=z or Z, σ_{IJ}^{(i,j)} is σ_{zz}^{(i,j)} (or ZZ^{(i,j)}), which are the traditional multiarray induction measurements. In this case, N represents the total number of tri-axial subarrays, and M represents the total number of the operational frequencies. Hence, there are 2*9*M*N R- and X-signal data values for every logging point.

In some embodiments, the tool 100 can be operated at five different frequencies, such as: 12, 36, 60, 72, and 84 kHz. That is, each subarray A₁, . . . A₄ can be operated at each frequency, with separation distances of L₁ for subarray A₄ equal to 80 inches, L₂ for subarray A₂ equal to 50 inches, L₃ for subarray A₃ equal to 29 inches, and L₄ for subarray A₄ equal to 17 inches.

The skin depth (SD=δ) for an MCI tool 100 operated at multiple frequencies is estimated by using Equation (3), where Rt is the true resistivity in the formation and f is the operational frequency:

$$δ = 19804 \cdot \sqrt{\frac{Rt}{f}} . \qquad ( 3 )$$

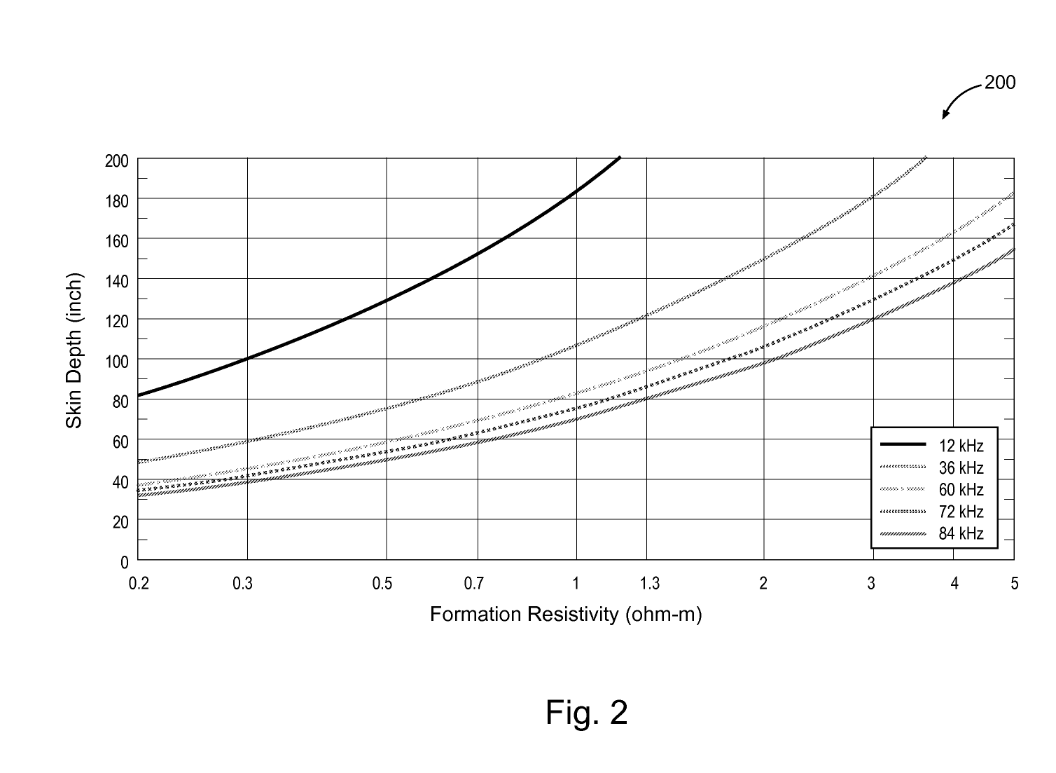

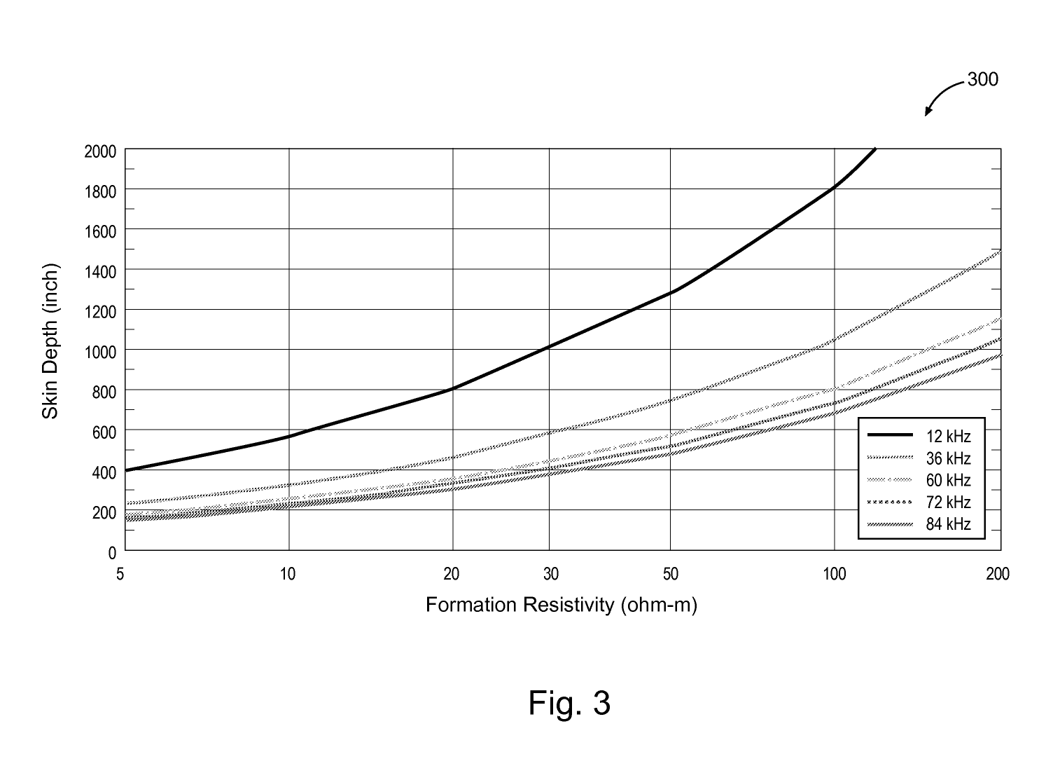

FIG. 2 is a graph 200 of skin depth versus formation true resistivity (Rt=0.2-5 ohm-m) over a range of operational frequencies for the MCI tool of FIG. 1. FIG. 3 is a graph 300 of skin depth versus formation true resistivity (Rt=5-200 ohm-m) over a range of operational frequencies for the MCI tool of FIG. 1. For the purposes of this document, “true resistivity” Rt is the standard language in the industry used to refer to the real value of resistivity in a formation, as opposed to the “apparent resistivity”, which is a raw measurement made by a tool, before corrections is applied.

Here δ is the skin depth, measured in inches, while the formation true resistivity Rt is measured in terms of ohm-m, and the measurement frequency is set forth in terms of Hertz (cycles/second). When the formation resistivity is transversely isotropic (TI), the true resistivity Rt is assigned an effective resistivity (geometric mean) determined by Equation (4), as follows:

Rt=\sqrt{Rh·Rv}, (4)

where Rh and Rv, components of the true resistivity Rt, are the formation horizontal resistivity and vertical resistivity, respectively, in the formation principal coordinate system.

When the formation is bi-axially anisotropic (BA), the value of Rt is determined by equation (5), as follows:

$$Rt = \sqrt{\sqrt{Rx \cdot Ry} \cdot Rz} , \qquad ( 5 )$$

where Rx, Ry, and Rz are the formation x-, y-, and z-directed resistivities in the formation principal coordinate system, respectively. It is noted that Equation (4) is actually a special case of equation (5), when Rx=Ry=Rh.

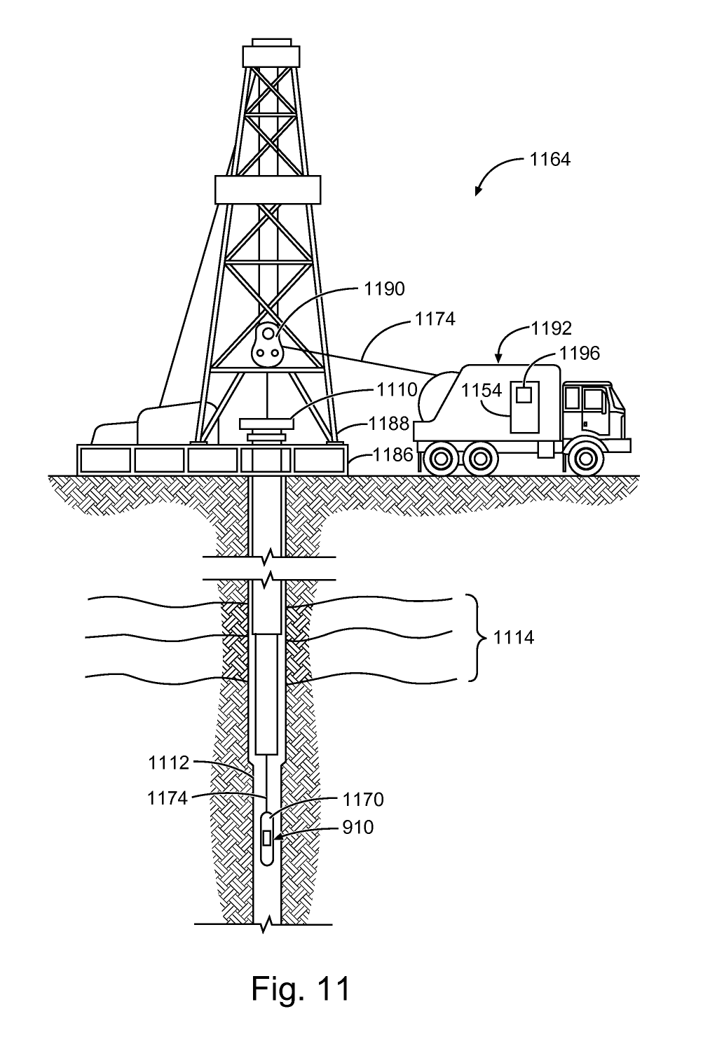

The simulated results for the skin depth for the MCI's five frequencies are showed in FIGS. 2 and 3 for Rt ranging from 0.2-5 ohm-m and 5-200 ohm-m, respectively. Thus, when the tool 100 in FIG. 11 has four subarrays A₁, . . . A₄ with Lₘ spacing of L₁=80 inches, L₂=50 inches, L₃=29 inches, and L₄=17 inches, and if it is assumed that the SD≥80 in, which ensures all arrays respond to the same earth model, then the graphs in each case provide useful information for guiding the use of MCI measurement data. That is,

For Rt=0.20-0.65 ohm-m, only 12 kHz data is used;

For Rt=0.65-1.00 ohm-m, only 12 kHz, 36 kHz data is used;

For Rt=1.00-1.20 ohm-m, only 12 kHz, 36 kHz, 60 kHz data is used;

For Rt=1.20-1.35 ohm-m, only 12 kHz, 36 kHz, 60 kHz, 72 kHz data is used; and

For Rt>1.35 ohm-m, all five frequencies can be used.

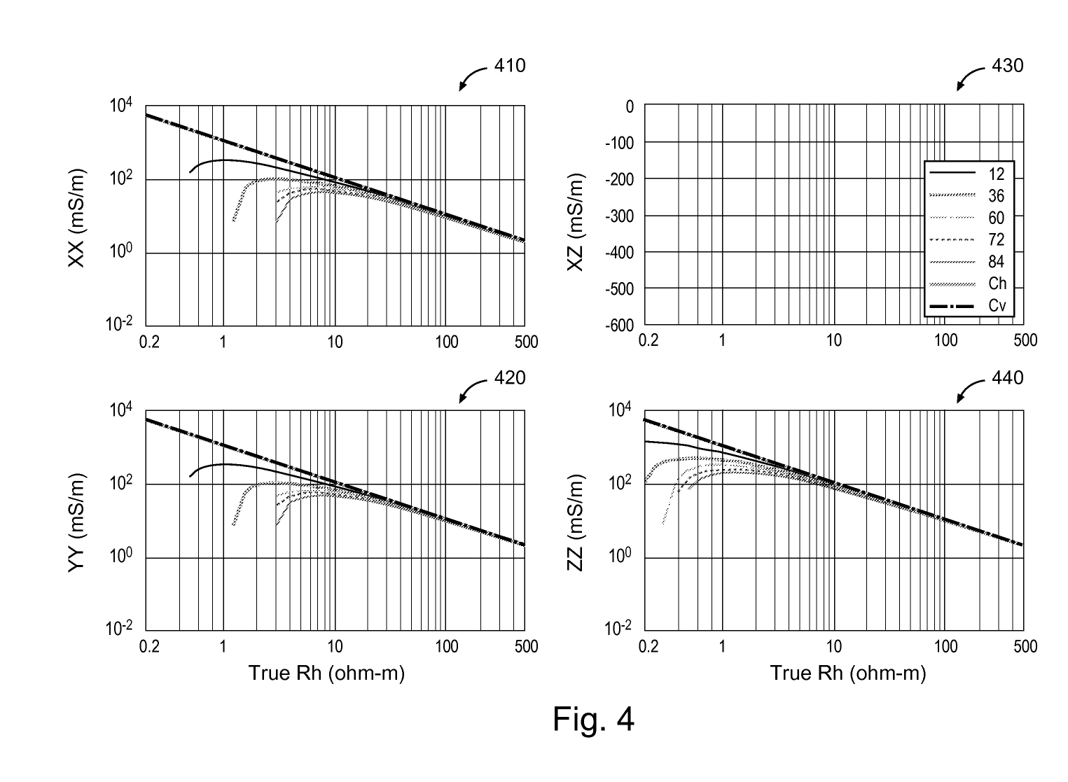

FIG. 4 illustrates simulated MCI responses (XX, XZ, YY, and ZZ) for array A1 of the MCI tool of FIG. 1, with dip=0 degrees, according to various embodiments. The anisotropic ratio=Ch/Cv=1. The graphs 410, 420, 430, and 440 show the XX, YY, XZ, and ZZ conductivities versus the horizontal component Rh of true resistivity, respectively.

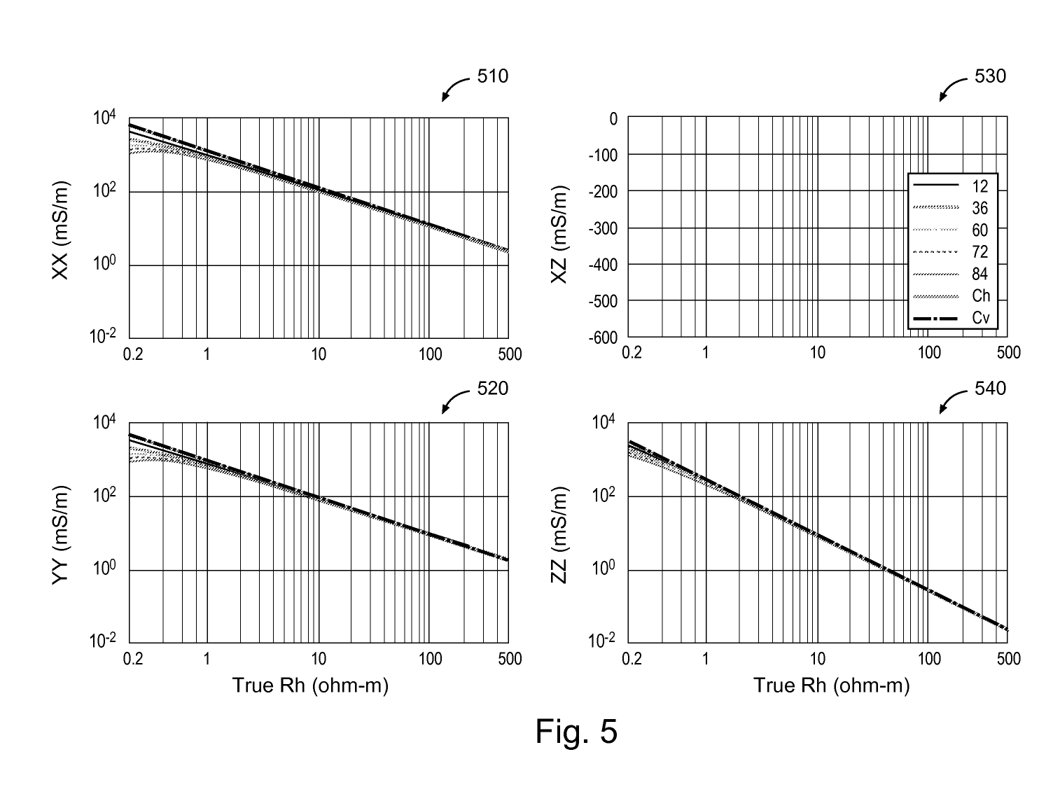

FIG. 5 illustrates simulated MCI responses (XX, XZ, YY, and ZZ) for array A4 of the MCI tool of FIG. 1, with dip=0 degrees, according to various embodiments. Again, the anisotropic ratio=Ch/Cv=1. The graphs 510, 520, 530, and 540 show the XX, YY, XZ, and ZZ conductivities versus the horizontal component Rh of true resistivity, respectively.

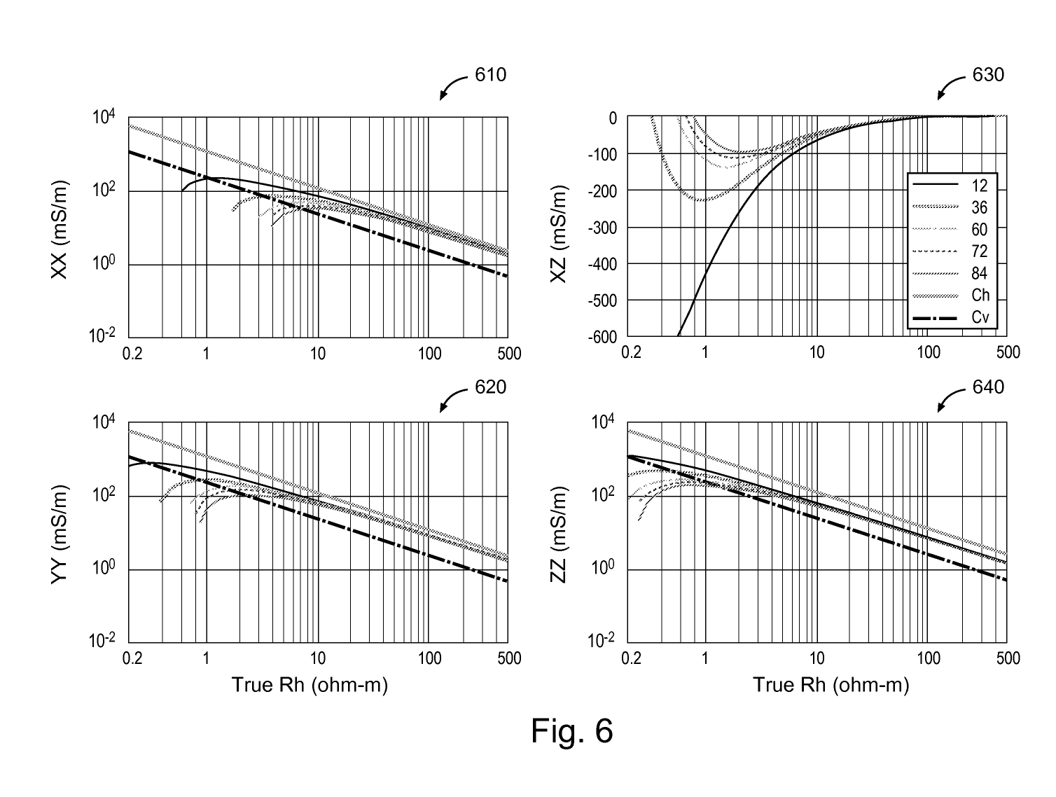

FIG. 6 illustrates simulated MCI responses (XX, XZ, YY, and ZZ) for array A1 of the MCI tool of FIG. 1, with dip=65 degrees, according to various embodiments. Here, the anisotropic ratio=Ch/Cv=5. The graphs 610, 620, 630, and 640 show the XX, YY, XZ, and ZZ conductivities versus the horizontal component Rh of true resistivity, respectively.

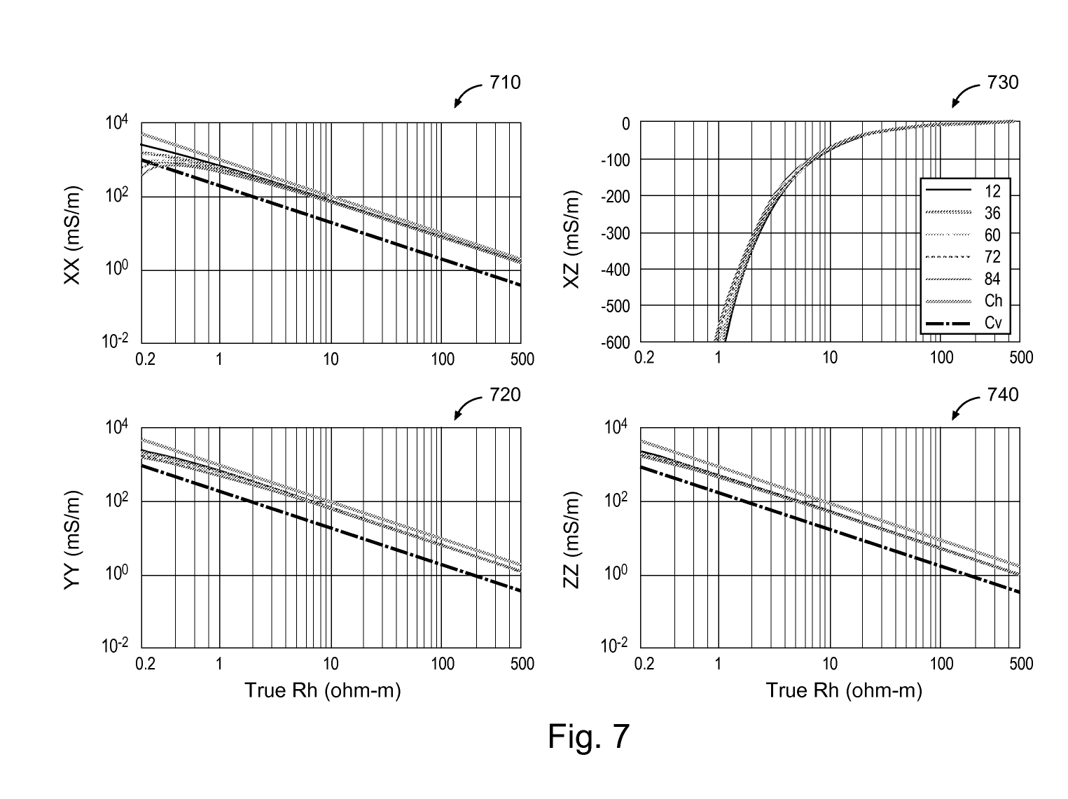

FIG. 7 illustrates simulated MCI responses (XX, XZ, YY, and ZZ) for array A4 of the MCI tool of FIG. 1, with dip=65 degrees, according to various embodiments. Again, Ch/Cv=5. The graphs 710, 720, 730, and 740 show the XX, YY, XZ, and ZZ conductivities versus the horizontal component Rh of true resistivity, respectively.

It is apparent from the figures that MCI tool response is affected by the measurement frequency, and formation resistivity (e.g., Rh as a component of true resistivity Rt). The simulation results in full-space (OD) homogenous formations for subarrays A₁ and A₄ (which has less separation between transmitters and receivers than subarray A₁) as a function of the frequency and resistivity are presented in each case, where it can be observed that the curves in all four panels of each figure can be described in terms of the following equations.

First, Equation (6), which provides an expression for horizontal conductivity:

Cₕ^{log}=fₕ(Rh)=kₕ·log Rₕ+C₀^{h}. (6)

Here Cₕ^{log}=log(Cₕ),

$${C}_{h} = \frac{1}{Rh} ,$$

where Ch and Rh are the formation horizontal conductive and resistivity, respectively, in a transversely isotropic formation; fₕ (Rh) denotes a function about Rh; and kₕ is the slope of the log-log linear equation with kₕ=)tan(45°, and C₀^{h} is the intercept. Therefore, Equation (6) describes the log linear relationship between Cₕ^{log} and log Rₕ.

Second, Equation (7), which provides an expression for vertical conductivity:

Cᵥ^{log}=fᵥ(Rh)=kᵥ·log Rₕ+C₀^{v}. (7)

Here Cᵥ^{log}=log(Cᵥ),

$${C}_{v} = \frac{1}{Rv} ,$$

Cv and Rv are the formation vertical conductivity and resistivity, respectively, in the transversely isotropic formation; fᵥ (Rh) denotes a function about Rh; kᵥ is the slope of the log-log linear equation with kᵥ=kₕ, and C₀^{v} is the intercept. Therefore, Equation (7) describes the log linear relationship between Cᵥ^{log} and log Rₕ.

For the nine components Cᵢⱼ of the MCI tool, we have

Cᵢⱼ^{log}=fᵢⱼ(Rh,Aₖ,fₗ); where (8)

i,j=x, y, z; A1, A2, . . . ; fₗ=12 kHz, 36 kHz, . . . , 72 kHz.

Here Cᵢⱼ^{log}=log(Cᵢⱼ), and (Rh, Aₖ fₗ) demonstrates that Cᵢⱼ^{log} can be expressed as a function of the three independent variables Rh, Aₖ, and fₗ, such that fᵢⱼ (Rh, Aₖ, fₗ) may be a complicated non-linear function, or a linear, or quasi-linear (e.g., log-linear) function.

In Equation (8), if i=j, then we have Equation (9) for three direct coupling components of the MCI tool: XX, YY, and ZZ:

C_{XX}^{log}=f_{XX}(Rh,Aₖ,fₗ),C_{YY}^{log}=f_{YY}(Rh,Aₖ,fₗ),

and C_{ZZ}^{log}=f_{ZZ}(Rh,Aₖ,fₗ) (9)

Thus, it is possible to have three different results from the simulation, with respect to the relationship between the tool response and the formation Rh values: (1) a non-linear relationship; (2) a quasi-linear (or log-linear) relationship, or (3) a linear relationship. For selecting MCI tool measurements associated with various frequencies, different response patterns can be used. For example, only data associated with measurements made at the lowest-frequency will be used for processing and interpretation when Equation (8) provides a non-linear relationship between the tool response and the formation Rh. On the other hand, when Equation (8) provides a linear relationship between the tool response and the formation Rh, only the measurements made with the highest available frequency will be used. Finally, a multi-frequency combination of measurements will be selected when Equation (8) provides a quasi-linear relationship between the tool response and the formation Rh values.

In a first example, assume that a T-R (one transmitter and one receiver) MCI tool is approximated as a point dipole tool, with apparent conductivity calculated from the measured magnetic fields by using the following equation:

σ=k·H, (10)

where σ is the apparent conductivity (in units of S/m), k is the tool constant familiar to those of ordinary skill in the art, and H is the magnetic field generated by the transmitter and measured by the receiver.

The Hzz component of the tool constant can be computed according to the following equation k1=2L/(μf), where L is the spacing between the transmitter and receiver (units are in meters), f is the frequency, and μ is the permeability of free space.

For the coupling components Hxx, Hyy, Hxy, and Hyx, the tool constants are computed using the equation k2=2·k1. For the Hzx, Hzy, Hxz, and Hyz coupling components, the tool constants are computed using the equation k3=4·k1.

Thus, to determine the corresponding H fields we have: for the Hzz component,

$$Hzz = \frac{μ f}{2 L} \cdot σ zz ;$$

for the Hxx, Hyy, Hxy, Hyx components,

$$Hij = \frac{μ f}{4 L} \cdot σ ij ,$$

where i,j=x, y; and for the Hxz, Hyz, Hzx, Hzy components,

$$Hij = \frac{μ f}{8 L} \cdot σ ij ,$$

where i, j=x, y, z and i≠j.

In general, measurements made at higher frequencies with respect to Equation (10) have smaller values than those made at lower frequencies, due to skin effect attenuation of the associated electromagnetic field. Thus, the following inequality relationship exists for two measurement frequencies:

$${H}_{f 1} \leq \frac{f 1}{f 2} \cdot {H}_{f 2} , and f 1 \geq f 2. \qquad ( 11 )$$

However, when the formation resistivity is relatively high, the skin effect can be ignored with respect to apparent conductivities. In other words, apparent conductivities are almost equal for different frequencies at relatively high resistivity values (e.g., Rt>100 ohm-m).

As a result, the following approximate relationship for the H field at two different frequencies (f1, f2) can be stated:

$${H}_{f 1} \approx \frac{f 1}{f 2} \cdot {H}_{f 2} , \qquad ( 12 )$$

where H_{f1} is the H field value at a frequency of f1, and H_{f2} is the H field value at a frequency of f2.

For example, if 12 kHz is used as a reference measurement frequency, the relationships between the reference frequency (12 kHz) and the other four measurement frequencies (36 kHz, 60 kHz, 72 kHz, and 84 kHz) can be expressed using the following equations:

H₃₆≤3·H₁₂;H₆₀≤5·H₁₂;H₇₂≤6·H₁₂;H₈₄≤7·H₁₂. (13)

With formations that have a relatively high value of Rt (e.g., Rt>100 ohm-m), we have:

H₃₆=3·H₁₂;H₆₀=5·H₁₂;H₇₂=6·H₁₂;H₈₄=7·H₁₂. (14)

Thus, higher-frequency measurements for a multi-frequency MCI tool may be useful due to their higher signal-noise ratios and reduced degree of skin effect. From the above discussion and FIGS. 4-7, it can be deduced that when the formation Rt>100 ohm-m, only the highest frequency measurements should be used for data processing and interpretation.

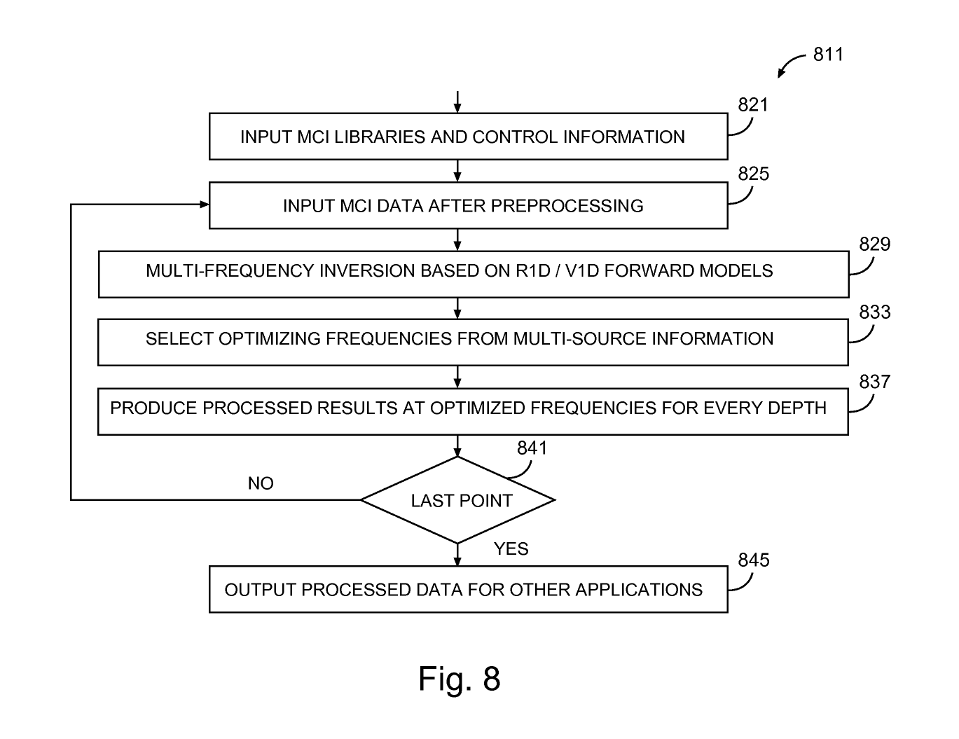

FIG. 8 is a workflow diagram 811 for a method of frequency selection and processing MCI tool measurements, according to various embodiments. The method 811 uses a combination of skin depth, linear vs. non-linear features of MCI tool responses, and bi-frequency relationship equations to provide a workflow for selecting MCI data. Here the diagram illustrates the use of frequency selection (at block 833) as part of a more comprehensive process that includes data acquisition, inversion, and data selection, based on the selected frequencies.

To begin, in some embodiments of the method 811, one or more databases are accessed at block 821 to obtain MCI tool operation and control information, including tool constants. Then the MCI tool is used to acquire data at multiple frequencies, at block 825.

At block 820, formation resistivity and dip are inverted independently from the MCI measurements at multiple frequencies based on OD/R1D/V1D (i.e., single layer/radial one-dimension/vertical one-dimension) forward models. Skin depth simulation and MCI response simulation can be obtained from known formation parameters, which can be simulated in real time or pre-calculated and then saved in data files as part of a data library (e.g., one of the databases accessed at block 821).

At block 833, frequencies are selected according to the various methods described herein.

At block 837, the acquired data corresponding to the selected frequencies is used in further processing, so that results are based on the selected frequency data, and not on data that corresponds to other frequencies.

At block 841, a determination is made as to whether processing is complete—has the last logging point been processed? If not, then the method 811 returns to block 825 to engage in additional processing. If so, then the method ends by providing the results of processing data associated with the selected frequencies at block 845. Additional petrophysical applications that may use the processing results include oil/gas/water recognition and in situ water/hydrocarbon saturation computation. In some embodiments, the workflow shown as part of the method 811, based on the OD/R1D forward models, can be performed in real-time, and the portion of the workflow based on the V1D model can be performed at the well site. Still further embodiments may be realized.

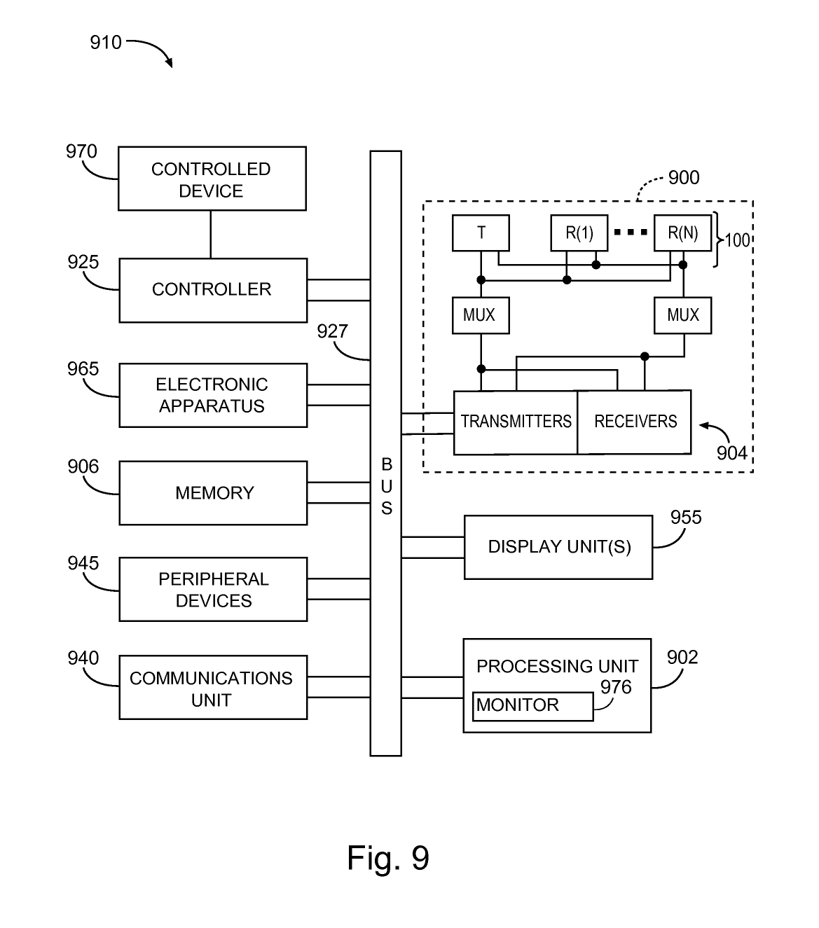

For example, FIG. 9 is a block diagram of a logging system 910 according to various embodiments. Referring now to FIGS. 1 and 9, it can be seen that the logging system 910 can receive measurement data from the tool 100. A controlled device 870, such as a display, bit steering mechanism, etc. can be operated in response to the measurements, as well as to processed results obtained from the measurements, including frequency/data selection methods that are described herein. Transmitting and receiving circuitry 904, along with multiplexers, may be used to drive signals to, and receive signals from the transmitters and receivers T, R in the tool 100. The logging system 910 thus may include one or more tools 100 operating in a wellbore.

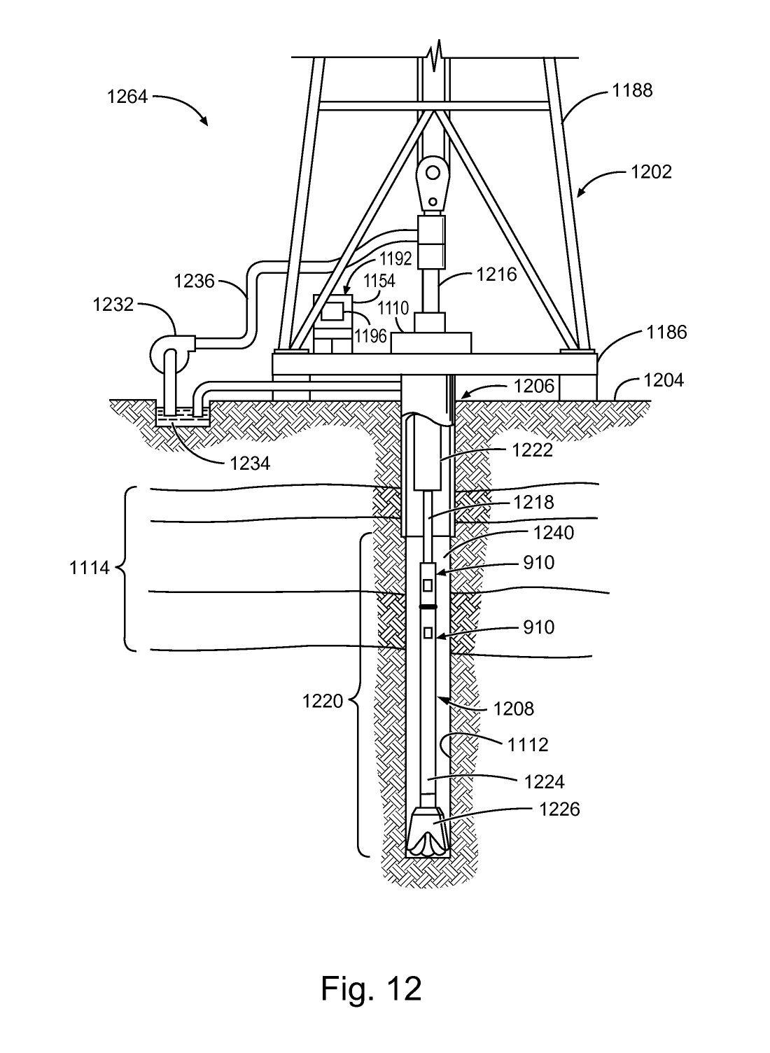

The processing unit 902 can couple to the transmitting and receiving circuitry 904 to obtain measurements from the tool 100 and other devices as described earlier herein. In some embodiments, a logging system 910 comprises one or more of the tools 100, as well as a housing 900 (see also FIGS. 11-12) that can form part of the tool 100, as well as other elements. The housing might therefore take the form of a wireline tool body, or a downhole tool as described in more detail below with reference to FIGS. 11 and 12. The processing unit 902 may be part of a surface workstation or attached to a downhole tool housing. In some embodiments, the processing unit 902 may be packaged within a housing 900.

The logging system 910 can include a controller 925, other electronic apparatus 965, and a communications unit 940. The controller 925 and the processing unit 902 can be fabricated to operate the transmitting and receiving circuitry 904 to interact with the transmitters and receivers T, R in the tool 100 to acquire measurement data, such as signals corresponding to formation resistivity measurements.

Electronic apparatus 965 (e.g., electromagnetic sensors, etc.) can be used in conjunction with the controller 925 to perform tasks associated with taking measurements downhole, using the tool 100. The communications unit 940 can include downhole communications in a wireline or drilling operation. Such downhole communications can include a telemetry.

The logging system 910 can also include a bus 927 to provide common electrical signal paths between the components of the logging system 910. The bus 927 can include an address bus, a data bus, and a control bus, each independently configured. The bus 927 can also use common conductive lines for providing one or more of address, data, or control, the use of which can be regulated by the controller 925.

The bus 927 can include instrumentality for a communication network. The bus 927 can be configured such that the components of the logging system 910 are distributed. Such distribution can be arranged between downhole components such as the housing 900 (and its elements) and components that can be disposed on the surface of a well. Alternatively, several of these components can be co-located such as on one or more collars of a drill string or on a wireline structure.

In various embodiments, the logging system 910 includes peripheral devices that can include displays 955, additional storage memory, or other controlled devices 970 that may operate in conjunction with the controller 925 or the processing unit 902. The display 955 can display diagnostic information for the tool 100 based on the signals generated according to embodiments described above. The display 955 can also be used to display one or more graphs, similar to or identical to those illustrated in FIGS. 2-7.

In an embodiment, the controller 925 can be fabricated to include one or more processors. The display 955 can be fabricated or programmed to operate with instructions stored in the processing unit 902 (for example in the memory 906) to implement a user interface to manage the operation of the tool 100 or components distributed within the logging system 910. This type of user interface can be operated in conjunction with the communications unit 940 and the bus 927. Various components of the logging system 910 can be integrated with the tool 100 and an associated housing 900 such that processing identical to or similar to the methods discussed with respect to various embodiments herein can be performed downhole. Thus, any one or more components of the tool 100 and/or controlled device 970 may be attached to or contained within the housing 900.

In some embodiments, the system 910 comprises a monitor 976. The monitor can exist as part of the processing unit 902, a shown, or apart from the processing unit 902. The monitor 976 may operate to keep track of various conditions indicated by the tool 100, as its measurements are processed according to various methods described herein. The monitor 976 may operate to indicate those transitions via a display, an audible or visible alarm, etc.

In various embodiments, a non-transitory machine-readable storage device can comprise instructions stored thereon, which, when performed by a machine, cause the machine to become a customized, particular machine that performs operations comprising one or more features similar to or identical to those described with respect to the methods and techniques described herein. A machine-readable storage device, herein, is a physical device that stores information (e.g., instructions, data), which when stored, alters the physical structure of the device. Examples of machine-readable storage devices can include, but are not limited to, memory 906 in the form of read only memory (ROM), random access memory (RAM), a magnetic disk storage device, an optical storage device, a flash memory, and other electronic, magnetic, or optical memory devices, including combinations thereof.

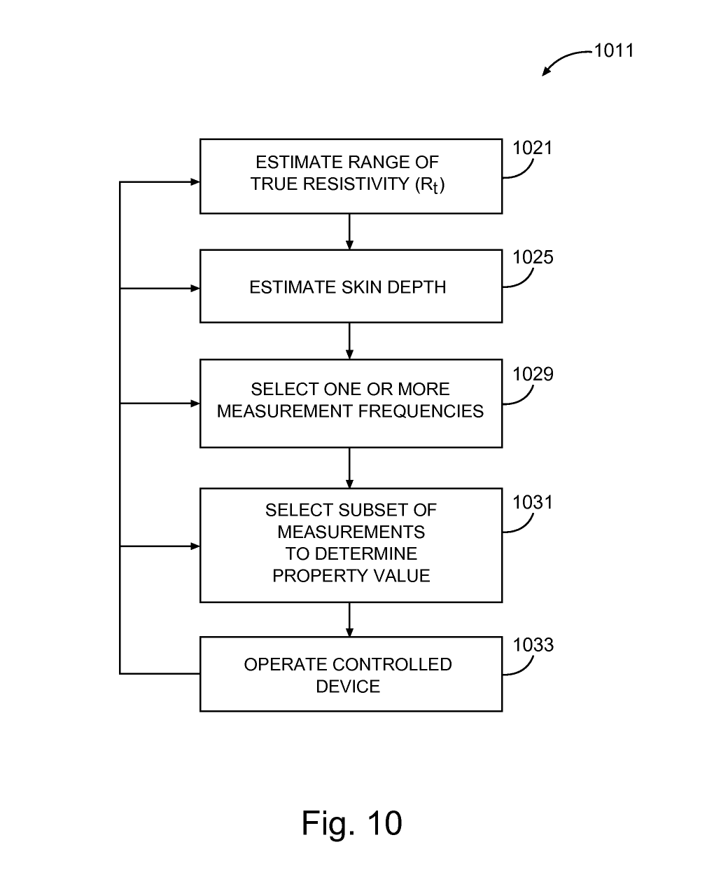

The physical structure of stored instructions may be operated on by one or more processors such as, for example, the processing unit 902. Operating on these physical structures can cause the machine to perform operations according to methods described herein. The instructions can include instructions to cause the processing unit 902 to store measurement data, look-up tables (e.g., generated by the methods of FIGS. 8 and 10), and other data in the memory 906. The memory 906 can store the results of measurements of formation parameters or parameters of the tool 100, to include gain parameters, calibration constants, identification data, etc. The memory 906 therefore may include a database, for example a relational database.

FIG. 10 is a flow diagram for a method 1011 of MCI tool frequency selection, according to various embodiments. In some embodiments, the method 1011 comprises estimating a range of true resistivity (Rt) in a formation at block 1021, and selecting a subset of the measurements associated with various frequencies associated with the measurements at block 1031, based on the range of true resistivity. This selection can be used to determine formation property values, such as true resistivity (i.e., RH and Rv), dip, and azimuth/strike, as determined from the data that has been acquired in association with the selected frequencies (effectively discounting acquired data that is associated with frequencies that are not selected). Thus, many embodiments may be realized.

For example, in some embodiments, the method 1011 may begin with estimating a range of true resistivity (Rt) in a geological formation, based on measurements made over multiple frequencies.

The selection of measurement frequencies can be refined, according to skin depth, and a reference frequency can be selected as f1 in the bi-frequency relationship, per Equation (12). Thus, in some embodiments, the method 1011 includes, at block 1025, estimating skin depth based on the range of resistivity

The skin depth can be estimated using an estimated anisotropic resistivity in the formation (e.g., a resistivity that varies as a function of x, y, and z directed resistivities in the formation), per Equation (5). Thus, estimating the skin depth at block 1025 may comprise determining the skin depth based on anisotropic resistivity in the formation.

The method 1011 may thus continue on to block 1029 to include selecting the at least one measurement frequency based on the skin depth.

The selection of one or more measurement frequencies can be refined, perhaps according to a linearity relationship between the measurements that have been made, and an estimated resistivity value, per Equation (8). Thus, the activity at block 1029 may comprise selecting the at least one measurement frequency based on a functional relationship between the measurements and an estimated resistivity value.

For example, the degree of linearity in the functional relationship can be evaluated based on a finite set of choices. Thus, the functional relationship may be determined as being one of a linear, quasi-linear, or nonlinear relationship.

The choice of a quasi-linear relationship may be determined when resistivity values fall within a selectable range of vertical and horizontal conductivity (i.e., Cv and Ch). Thus, the functional relationship in some embodiments is determined to be quasi-linear when resistivity values included in the measurements fall between a selected range of vertical conductivity and horizontal conductivity.

The inverted horizontal resistivity (Rh) may be used for the estimated resistivity value. Thus, in some embodiments, the estimated resistivity value is a horizontal resistivity value derived from the measurements.

The method 1011 may continue on to block 1031 to include selecting a subset of the measurements associated with at least one measurement frequency included in the multiple frequencies. The selection may be based on the range of the true resistivity, as well as the skin depth, to determine the value of a property of the geological formation.

The bi-frequency relationship formula, per Equation (12), can be used to weight measurements corresponding to different frequencies when multiple frequencies result from the skin depth selection technique of block 1029. Thus, the activity at block 1031 may comprise, after selecting multiple frequencies based on skin depth, selecting a weighted combination of the measurements associated with at least two frequencies included in the at least one measurement frequency.

The bi-frequency relationship formula can likewise be used to weight the measurements corresponding to different frequencies when multiple frequencies result from the evaluation of the linearity in the functional relationship selection at block 1029. Thus, the activity at block 1031 may comprise, after selecting multiple frequencies based on a functional relationship, selecting a weighted combination of the measurements associated with at least two frequencies included in the at least one measurement frequency.

The formation property value, such as true resistivity (Rt), can be used to control a variety of devices. Thus, in some embodiments, the method 1011 may include, at block 1033, operating a controlled device according to the value of the property.

The value of the property can be used to control drilling operations, such as adjusting the weight on bit, adjusting bit rotation rate, etc. Thus, the activity at block 1033 may comprise controlling drilling operations in the geological formation based on the value of the property. In some embodiments, controlling the drilling operations comprises operating a geosteering device to select a drilling direction in the geological formation, based on the value of the property.

The value of the property can be published for viewing, perhaps in the form of 2D or 3D graphs. Thus, in some embodiments, the activity of operating a controlled device at block 1033 comprises publishing the value of the property, or a derived version of the value of the property, in a human-readable form.

The determined property values can be stored for transportation, perhaps in a storage device that can be transported or that can be copied through the Internet. Thus, in some embodiments, the activity of operating a controlled device at block 1033 comprises recording the value of the property in a form that can be transported physically or electronically.

As noted in FIG. 8, the method of frequency selection (detailed in FIG. 10) can serve as the foundation of an over-arching inversion process. Thus, in some embodiments, at blocks 1025, 1029, and 1031, the activities of estimating and selecting are repeated, to select the at least one measurement frequency, over a range of depths in the geological formation, as part of a multi-frequency inversion process. Still further embodiments may be realized.

For example, as described earlier herein, resistivity measurement tools can be used in an LWD assembly or a wireline logging tool. FIG. 11 depicts an example wireline system, according to various embodiments. FIG. 12 depicts an example drilling rig system, according to various embodiments.

FIG. 11 depicts an example wireline system 1164, according to various embodiments. FIG. 12 depicts an example drilling rig system 1264, according to various embodiments. Either of the systems in FIGS. 11 and 12 are operable to control tools 100 (e.g., separately, or as part of systems 910) to conduct measurements in a wellbore. Thus, the systems 1164, 1264 may comprise portions of a wireline logging tool body 1170 as part of a wireline logging operation, or of a downhole tool 1224 (e.g., a drilling operations tool) as part of a downhole drilling operation.

Returning now to FIG. 11, a well during wireline logging operations can be seen. In this case, a drilling platform 1186 is equipped with a derrick 1188 that supports a hoist 1190.

Drilling oil and gas wells is commonly carried out using a string of drill pipes connected together so as to form a drilling string that is lowered through a rotary table 1110 into a wellbore or borehole 1112. Here it is assumed that the drilling string has been temporarily removed from the borehole 1112 to allow a wireline logging tool body 1170, such as a probe or sonde, to be lowered by wireline or logging cable 1174 into the borehole 1112. Typically, the wireline logging tool body 1170 is lowered to the bottom of the region of interest and subsequently pulled upward at a substantially constant speed.

During the upward trip, at a series of depths the instruments (e.g., tools 100, and/or other elements of system 910 shown in FIG. 9) included in the tool body 1170 may be used to perform measurements on the subsurface geological formations adjacent the borehole 1112 (and the tool body 1170). The measurement data can be communicated to a surface logging facility 1192 for storage, processing, and analysis. The logging facility 1192 may be provided with electronic equipment for various types of signal processing, which may be implemented by any one or more of the components of the system 910 and/or a display 1196 to view the results. Similar formation evaluation data may be gathered and analyzed during drilling operations (e.g., during LWD operations, and by extension, sampling while drilling).

In some embodiments, the tool body 1170 comprises one or more tools 100 for obtaining and analyzing electromagnetic field measurements in a subterranean formation through a borehole 1112. The tool is suspended in the wellbore by a wireline cable 1174 that connects the tool to a surface control unit (e.g., comprising a workstation 1154, which can also include a display). The tool may be deployed in the borehole 1112 on coiled tubing, jointed drill pipe, hard wired drill pipe, or any other suitable deployment technique.

Turning now to FIG. 12, it can be seen how a system 1264 may also form a portion of a drilling rig 1202 located at the surface 1204 of a well 1206. The drilling rig 1202 may provide support for a drill string 1208. The drill string 1208 may operate to penetrate the rotary table 1110 for drilling the borehole 1112 through the subsurface formations 1114. The drill string 1208 may include a Kelly 1216, drill pipe 1218, and a bottom hole assembly 1220, perhaps located at the lower portion of the drill pipe 1218.

The bottom hole assembly 1220 may include drill collars 1222, a downhole tool 1224, and a drill bit 1226. The drill bit 1226 may operate to create the borehole 1112 by penetrating the surface 1204 and the subsurface formations 1214. The downhole tool 1224 may comprise any of a number of different types of tools including MWD tools, LWD tools, and others.

During drilling operations, the drill string 1208 (perhaps including the Kelly 1216, the drill pipe 1218, and the bottom hole assembly 1220) may be rotated by the rotary table 1110. Although not shown, in addition to, or alternatively, the bottom hole assembly 1220 may also be rotated by a motor (e.g., a mud motor) that is located downhole. The drill collars 1222 may be used to add weight to the drill bit 1226. The drill collars 1222 may also operate to stiffen the bottom hole assembly 1220, allowing the bottom hole assembly 1220 to transfer the added weight to the drill bit 1226, and in turn, to assist the drill bit 1226 in penetrating the surface 1204 and subsurface formations 1214.

During drilling operations, a mud pump 1232 may pump drilling fluid (sometimes known by those of ordinary skill in the art as “drilling mud”) from a mud pit 1234 through a hose 1236 into the drill pipe 1218 and down to the drill bit 1226. The drilling fluid can flow out from the drill bit 1226 and be returned to the surface 1204 through an annular area 1240 between the drill pipe 1218 and the sides of the borehole 1112. The drilling fluid may then be returned to the mud pit 1234, where such fluid is filtered. In some embodiments, the drilling fluid can be used to cool the drill bit 1226, as well as to provide lubrication for the drill bit 1226 during drilling operations. Additionally, the drilling fluid may be used to remove subsurface formation cuttings created by operating the drill bit 1226.

Thus, it may be seen that in some embodiments, the systems 1164, 1264 may include a drill collar 1222, a downhole tool 1224, and/or a wireline logging tool body 1170 to house one or more tools 100 similar to or identical to the tool 100 shown in FIG. 1. The tool 100, as well as other components of the system 910 in FIG. 9 may comprise part or all of the tool 1224 or the tool body 1170.

Thus, for the purposes of this document, the term “housing” may include any one or more of a drill collar 1222, a downhole tool 1224, or a wireline logging tool body 1170 (all having an outer wall, to enclose or attach to magnetometers, sensors, antenna, coils, fluid sampling devices, pressure measurement devices, transmitters, receivers, acquisition and processing logic, and data acquisition systems). The tool 1224 may comprise a downhole tool, such as an LWD tool or MWD tool. The wireline tool body 1170 may comprise a wireline logging tool, including a probe or sonde, for example, coupled to a logging cable 1174. Many embodiments may thus be realized.

For example, a system 1164, 1264 may comprise a downhole tool body, such as a wireline logging tool body 1170 or a downhole tool 1224 (e.g., an LWD or MWD tool body), and one or more transmitters and receivers T, R to be constructed and operated as described previously.

Thus referring to FIGS. 1, 9 and 11-12, it can be seen that in some embodiments an apparatus may comprise one or more sensors (e.g., the receivers R mounted to a downhole tool 100, to make measurements, and a processing unit (e.g., the processing unit 902) to select measurements based on an estimated range of true resistivity (Rt) in a geological formation surrounding the tool 100.

In some embodiments, an apparatus comprises at least one sensor (e.g., one or more receivers R, such as receivers Rₓ^{m}, R_{y}^{m}, and R_{z}^{m} and/or receivers Rₓ^{b}, R_{y}^{b}, and R_{z}^{b}, perhaps forming part of one or more tri-axial subarrays A₁, . . . A_{N} comprising transmitter triads (Tₓ, T_{y}, and T_{z}), and separate main and/or bucking receiver triads, (Rₓ^{m}, R_{y}^{m}, and R_{z}^{m}) and Rₓ^{b}, R_{y}^{b}, and R_{z}^{b}) attached to a downhole tool housing 900, with the sensor(s) used to make measurements in a geological formation. The apparatus may further comprise a processing unit 902 to estimate a range of true resistivity (Rt) in the geological formation, based on measurements made over multiple frequencies, and to select a subset of the measurements associated with at least one measurement frequency included in the multiple frequencies, based on the range of the true resistivity, to determine a value of a property of the geological formation.

The apparatus may be coupled to a bit steering mechanism. Thus, in some embodiments, the apparatus may comprise a bit steering mechanism (e.g., comprising a controlled device 970) communicatively coupled to the processing unit 902. The bit steering mechanism may operate in response to the value of the property, as determined by the processing unit 902, to control drilling operations in the geological formation.

A monitor may operate to keep track of transitions from invaded to non-invaded regions of the formation, and perhaps, to indicate those transitions via a display, alarm, etc. Thus, in some embodiments, an apparatus comprises a monitor 976 to indicate transitions from invaded to non-invaded regions of the geological formation, based on the value of the property, as determined by the processing unit 902.

A database of formation property values over depth can be created and used for calibration, drilling control, etc. Thus, in some embodiments, an apparatus comprises a memory 906 accessible by the processing unit 902, the memory to store a plurality of formation property values, including the value of the property, as determined by the processing unit 902.

A variety of tools can be used to acquire measured data, including electromagnetic tools, such as multi-component or triaxial induction tools. Thus, in some embodiments, the downhole tool housing in the apparatus comprises one of a wireline tool housing or a drill string tool housing.

Any of the above components, for example the tool 100, or the systems 910, 1164, 1264 (and each of their elements) may all be characterized as “modules” herein. Such modules may include hardware circuitry, and/or a processor and/or memory circuits, software program modules and objects, and/or firmware, and combinations thereof, as desired by the architect of the tools 100 and systems 910, 1164, 1264 and as appropriate for particular implementations of various embodiments. For example, in some embodiments, such modules may be included in an apparatus and/or system operation simulation package, such as a software electrical signal simulation package, a power usage and distribution simulation package, a power/heat dissipation simulation package, a measured radiation simulation package, and/or a combination of software and hardware used to simulate the operation of various potential embodiments.

It should also be understood that the apparatus and systems of various embodiments can be used in applications other than for logging operations, and thus, various embodiments are not to be so limited. The illustrations of tools 100 and systems 910, 1164, 1264 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, processor modules, embedded processors, data switches, and application-specific modules.

It should be noted that the methods described herein at FIGS. 8 and 10 do not have to be executed in the order described, or in any particular order. Moreover, various activities described with respect to the methods identified herein can be executed in iterative, serial, or parallel fashion. Activities in one method may be substituted for those of another method. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. For example, the programs may be structured in an object-orientated format using an object-oriented language such as Java or C#. In another example, the programs can be structured in a procedure-orientated format using a procedural language, such as assembly or C. The software components may communicate using any of a number of mechanisms well known to those of ordinary skill in the art, such as application program interfaces or interprocess communication techniques, including remote procedure calls. The teachings of various embodiments are not limited to any particular programming language or environment.

In summary, using the apparatus, systems, and methods disclosed herein may utilize multi-source information for selecting optimal multi-frequency MCI measurements. This selection process provides more consistent and accurate measurement results, and in turn, increased customer satisfaction.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Although specific embodiments have been illustrated and described herein, it will be appreciated by those of ordinary skill in the art that any arrangement that is calculated to achieve the same purpose may be substituted for the specific embodiments shown. Various embodiments use permutations or combinations of embodiments described herein. It is to be understood that the above description is intended to be illustrative, and not restrictive, and that the phraseology or terminology employed herein is for the purpose of description. Combinations of the above embodiments and other embodiments will be apparent to those of ordinary skill in the art upon studying the above description.

1. An apparatus, comprising:
at least one sensor attached to a downhole tool housing, the sensor to make measurements in a geological formation; and
a processing unit to estimate a range of true resistivity in the geological formation, based on measurements made over multiple frequencies, and to select a subset of the measurements associated with at least one measurement frequency included in the multiple frequencies, based on the range of the true resistivity, to determine a value of a property of the geological formation.

2. The apparatus according to claim 1, further comprising:
a bit steering mechanism communicatively coupled to the processing unit, the bit steering mechanism to operate in response to the value of the property, as determined by the processing unit, to control drilling operations in the geological formation.

3. The apparatus according to claim 1, further comprising:
a monitor to indicate transitions from invaded to non-invaded regions of the geological formation, based on the value of the property, as determined by the processing unit.

4. The apparatus according to claim 1, further comprising:
a memory accessible by the processing unit, the memory to store a plurality of formation property values, including the value of the property, as determined by the processing unit.

5. The apparatus according to claim 1, wherein the downhole tool housing comprises one of a wireline tool housing or a drill string tool housing.

6. A method comprising:
estimating a range of true resistivity in a geological formation, based on measurements made over multiple frequencies; and
selecting a subset of the measurements associated with at least one measurement frequency included in the multiple frequencies, based on the range of the true resistivity, to determine a value of a property of the geological formation.

7. The method according to claim 6, further comprising:
operating a controlled device according to the value of the property.

8. The method according to claim 7, wherein operating the controlled device further comprises:
controlling drilling operations in the geological formation based on the value of the property.

9. The method according to claim 8, wherein controlling the drilling operations comprises:
operating a geosteering device to select a drilling direction in the geological formation, based on the value of the property.

10. The method according to claim 7, wherein operating the controlled device comprises:
publishing the value of the property, or a derived version of the value of the property, in a human-readable form.

11. The method according to claim 7, wherein operating the controlled device comprises:
recording the value of the property in a form that can be transported physically or electronically.

12. The method according to claim 6, further comprising:
estimating skin depth based on the range of resistivity; and
selecting the at least one measurement frequency based on the skin depth.

13. The method according to claim 12, further comprising:
selecting a weighted combination of the measurements associated with at least two frequencies included in the at least one measurement frequency.

14. The method according to claim 12, wherein estimating the skin depth comprises:
determining the skin depth based on anisotropic resistivity in the formation.

15. The method according to claim 6, further comprising;
selecting the at least one measurement frequency based on a functional relationship between the measurements and an estimated resistivity value.

16. The method according to claim 15, wherein the functional relationship is determined as being one of linear, quasi-linear, or nonlinear.

17. The method according to claim 16, wherein the functional relationship is determined to be quasi-linear when resistivity values included in the measurements fall between a selected range of vertical conductivity and horizontal conductivity.

18. The method according to claim 15, wherein the estimated resistivity value is a horizontal resistivity value derived from the measurements.

19. The method according to claim 15 further comprising:
selecting a weighted combination of the measurements associated with at least two frequencies included in the at least one measurement frequency.

20. The method according to claim 6, wherein the estimating and the selecting are repeated, to select the at least one measurement frequency, over a range of depths in the geological formation, as part of a multi-frequency inversion process.
